(19) United States
(12) Patent Application Publication
(10) Pub. No.: US 2017/0362256 A1
(43) Pub. Date: Dec. 21, 2017

(54) Microwave Assisted Alcohol Condensation on Oxide Surfaces

(71) Applicants: Byron D. Gates, Burnaby (CA); Woohyuk Lee, Surrey (CA)

(72) Inventors: Byron D. Gates, Burnaby (CA); Woohyuk Lee, Surrey (CA)

(21) Appl. No.: 15/525,501

(22) PCT Filed: Nov. 24, 2015
(86) PCT No.: PCT/US2015/062419

§ 371 Date: May 9, 2017

Related U.S. Application Data
(60) Provisional application No. 62/083,726, filed on Nov. 24, 2014.

(51) Int. Cl. C07F 7/02; C23C 22/73; C09D 5/00

(52) U.S. Cl. CPC C07F 7/025; C09D 5/00; C23C 22/73

(57) ABSTRACT

A method for forming a modified surface comprising (1) on a substrate is provided wherein a reactive groups on the surface is condensed with alcohols, thiols, silanes or phosphonic acid in the presence of microwave energy.

### BACKGROUND

The present invention claims priority to pending U.S. Provisional Application No. 62/083,726 filed Nov. 24, 2014 which is incorporated herein by reference.

### BACKGROUND

The present invention is related to an improved method for forming derivatized surfaces and modified surfaces formed thereby. More specifically, the present invention is related to a method of forming Self-Assembled Monolayers (SAMs) by a microwave assisted condensation reaction of a surface modification compound with an active oxide group preferably a hydroxyl on an oxide surface.

It is an ongoing desire to provide surfaces with specific functionality. The functionality may be reactive wherein certain materials either selectively bind to or react at the surface or the functionality may be for passivation to inhibit binding and reacting at the surface thereby protecting the surface. Regardless of the desired surface characteristics there is an ongoing desire for methods whereby surfaces can be selectively modified.

The present invention provides a method of derivatizing oxide surfaces, such as silica surfaces, thereby providing a material which can be used in a variety of industries and for a variety of applications.

### SUMMARY OF THE INVENTION

It is an object of the invention to provide a method for derivatizing an oxide surface and for example a silica surface.

A particular feature of the invention is the ability to form M-O—R, M-S—R, M-OP(O)OHR or M-O—SiR bonds wherein M, which is a semiconductor or transition metal or from a mixture therein, is integral to a surface and the R group(s) provide functionality.

A particular advantage of the invention is the ability to form the bond by microwave energy which is readily available, easily controlled and scalable.

These and other advantages, as will be realized, are provided in a modified surface comprising

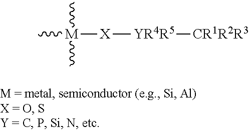

on a substrate wherein:
X is selected from O or S;
Y is selected from C, Si, P, N; R⁴ and R⁵ are independently selected from H; single or double bonded oxygen; halogens; substituted or unsubstituted straight or branched alkanes, alkenes or alkynes of 1 to 5 carbons; R¹, R², and R³ are independently selected from H with the proviso that no more than 2 of R¹, R², and R³ are hydrogen; substituted or unsubstituted straight or branched alkanes, alkenes or alkynes of 1-100 carbons; R¹, R², and R³ can be taken in pairs to represent substituted or unsubstituted cyclic alkane, cyclic alkene or cyclic alkyne; R¹, R², and R³ can be independently selected from halogens; and —(R⁶O)_{z}—R⁷ wherein R⁶ is an alkyl of 1-3 carbons; R⁷ is a terminal group.

Yet another advantage is provided in a method of forming a modified surface comprising:
combining a substrate comprising a surface comprising a reactive group with a surface modification compound defined by Formula II

Z—YR⁴R⁵—CR¹R²R³ Formula II
wherein Z of Formula II is a leaving group; such as halogens, hydroxyl groups, or H. Y is selected from C, Si, P, N; R⁴ and R⁵ are independently selected from H; single or double bonded oxygen; halogens; substituted or unsubstituted straight or branched alkanes, alkenes or alkynes of 1 to 5 carbons. R¹, R², and R³ are independently selected from H with the proviso that no more than 2 of R¹, R², and R³ are hydrogen; substituted or unsubstituted straight or branched alkanes, alkenes or alkynes of 1-100 carbons; R¹, R², and R³ can be taken in pairs to represent substituted or unsubstituted cyclic alkane, cyclic alkene or cyclic alkyne; R¹, R², and R³ can be independently selected from halogens; and —(R⁶O)_{z}—R⁷ wherein R⁶ is an alkyl of 1-3 carbons; R⁷ is a terminal group; and subjecting the combination to microwave radiation with an energy and duration sufficient to cause condensation and reaction of the surface modification compound and the reactive group.

### BRIEF DESCRIPTION OF FIGURES

FIG. 1 is a flow chart representation of the invention.

FIG. 2 is a schematic representation of the invention illustrated with alkyl alcohols as exemplary embodiments.

FIGS. 3-6 are graphical representations of the water contact angle versus microwave time for various control samples.

FIG. 7 is an AFM image of an embodiment of the invention.

FIG. 8 is a graphical representation of the water contact angle as a function of microwave radiation time for an embodiment of the invention.

FIG. 9 is an XPS of an embodiment of the invention.

FIGS. 10-11 are AFM images of an embodiment of the invention.

FIG. 12 is an XPS of embodiments of the invention.

FIG. 13 is a graphical comparison of the water contact angle as a function of reaction time for substrates treated separately by heating with either microwave radiation or use of a convective oil bath held at 180° C.

FIG. 14A is a graphical representation of the water contact angle as a function of microwave power in Watts for silicon and quartz substrates while immersed in 1-octanol. The reaction time was 5 minutes.

FIG. 14B is a graphical representation of the temperature profile of microwave reaction at 300 W for 5 minutes for both silicon and quartz substrates immersed in 1-octanol.

FIG. 15A is a schematic representation of the invention illustrated with 1H,1H-perfluoro-1-octanol as exemplary embodiments.

FIG. 15B, and C is XPS results of an embodiment of the reaction shown in FIG. 15A achieved with a neat solution of 1H,1H-perfluoro-1-octanol.

FIG. 16A is a schematic representation of the invention illustrated with 2-phenyl-1-ethanol as exemplary embodiments.

FIG. 16B is a graphical representation of the water contact angle versus duration of microwave radiation for the reaction in a neat solution of 2-phenyl-1-ethanol as exemplary embodiments.

FIG. 16C, and D are XPS results of an embodiment of the reaction shown in FIG. 16A achieved with a neat solution of 2-phenyl-1-ethanol.

FIG. 17A is a schematic representation of the invention illustrated with ethanolamine as exemplary embodiments.

FIG. 17B,C, and D are XPS results of an embodiment of the reaction shown in FIG. 17A achieved with a neat ethanolamine.

FIG. 18A is a schematic representation of the invention illustrated with choline chloride as exemplary embodiments.

FIG. 18B, C, and D are XPS results of an embodiment of the reaction shown in FIG. 18A achieved with a 1M solution of choline chloride in water.

FIG. 19A is a graphical representation of zeta potential measurements at different pH of silica nanoparticles and silica nanoparticles after functionalization with an aqueous solution of 1M choline chloride.

FIG. 19B, C, and D are XPS results of an embodiment of the reaction achieved on silica nanoparticles with a 1M solution of choline chloride in water.

FIG. 20A is a schematic representation of the invention illustrated with 4-hydroxybenzaldehyde as exemplary embodiments.

FIG. 20B and C are XPS results of an embodiment of the reaction achieved with a 1M solution of 4-hydroxybenzaldehyde in diethylene glycol diethyl ether.

### DESCRIPTION

The instant invention is specific to a method of forming a derivatized surface, and more specifically a derivatized oxide surface wherein hydroxyl groups on the surface are condensed with compounds such as alcohols, thiols, silanes or phosphonic acid. The invention provides a way to conveniently derivatize a surface thereby providing a functionalized surface, which either has desired properties or which contains functional groups which can be further derivatized.

The surface species is defined by Formula I:

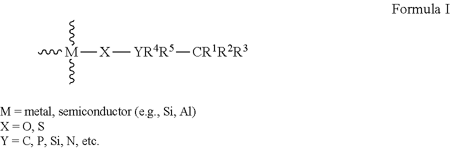

wherein the surface species of Formula I is formed by microwave assisted condensation of a surface modification compound defined by Formula II:

Z—YR⁴R⁵—CR¹R²R³ Formula II
wherein Z of Formula II is a leaving group such as a hydrogen, hydroxyl, or a halogen which is removed during condensation thereby forming a direct M-X bond represented in Formula I.

In Formula I and Formula II X is selected from O or S and most preferably X is O.

R⁴ and R⁵ are independently selected from H; single or double bonded oxygen; halogens; substituted or unsubstituted straight or branched alkanes, alkenes or alkynes of 1 to 5 carbons.

In one embodiment R¹, R², and R³ are independently selected from H with the proviso that no more than 2 of R¹, R², and R³ are hydrogen; straight or branched alkanes, alkenes or alkynes of 1-100 carbons, more preferably 1-50 carbons, even more preferably 1-20 carbons and even more preferably 5-12 carbons. R¹, R², and R³ can be taken in pairs to represent a cyclic alkane, cyclic alkene or cyclic alkyne. The alkanes, alkenes or alkynes are either unsubstituted or substituted with halogens, hydroxyl, amines, aryl, sulfates, phosphates, alkyl ethers, alkyls, cyclic alkyls, ketones, aldehydes, carboxylic acids, esters, nucleic acids, amino acids, sugars, carbohydrates, hormones, proteins, neurotransmitters, catechols, ethers, ionic groups, organo-sulfurs, —N═N—, —N═N═N—, or combinations thereof. In one embodiment at least one of R¹, R², or R³ is substituted with at least one fluorine and more preferably at least one of R¹, R², or R³ is a fluorinated or perfluorinated alkyl, alkene or alkyne.

R¹, R², and R³ can be independently selected from halogens.

In one embodiment at least one of R¹, R², or R³ is —(R⁶O)_{z}—R⁷ wherein R⁶ is an alkyl of 1-3 carbons and preferably —CH₂CH₂—; R⁷ is a terminal group preferably selected from —OH and an alkyl of 1 to 3 carbons and R⁶ is more preferably selected from —OH and —CH₂CH₃ and z is an integer of 1 to 20.

Particularly suitable alcohols of Formula II are represented by: saturated and unsaturated alcohols with 1 to 100 carbons, more preferably 1-50, even more preferably 1-20 and preferably 5 to 12 carbons; polyalklene glycols, more preferably polyethylene glycol and more preferably polyethylene glycol with a molecular weight low enough to be liquid at 25° C.; fluorinated alcohols and particularly perfluorinated alcohols and even more preferably perfluorinated alcohols which are liquid at 25° C.; phenyl alcohols and particularly phenyl alcohols with a formula of HODC₆H₅ wherein D represents a bond or a saturated or unsaturated alkyl of 1-6 carbons and more preferably 1-3 carbons; polar alcohols such as alkanolamines with 2-4 carbons and preferably 2 carbons wherein the amine is primary, secondary, tertiary or quaternary; vitamins and particularly thiamine, ascorbic acid, cholecalcifero, riboflavin, vitamin E, ergocalciferol, pantothenic acid, pyridoxal, pyridoxamine or pyridoxine; sugars and particularly n-acetylglucosamine, glucosamine, D-glucose and sucrose; amino acids and particularly serine, threonine and tyrosine; nucleic acids such as adenosine derivatives including adenosine triphosphate and adenosine monophosphate; catechols including catechol and catechin and hormones or neurotransmitters including dopamine, norepinephrine, epinephrine, cholesterol, testosterone.

Particularly preferred thiols of Formula II are saturated and unsaturated thiols with 1 to 100 carbons, more preferably 1-50, even more preferably 1-20 and preferably 5 to 12 carbons; fluorinated thiols and particularly perfluorinated thiols.

Particularly preferred silanes include include chlorosilanes with saturated and unsaturated alkyl groups with 1 to 100 carbons, more preferably 1-50, even more preferably 1-20 and preferably 5 to 12 carbons; fluorinated alkyl groups and particularly perfluorinated alkyl groups.

It is preferred that the surface modification compound of Formula II be liquid at 25° C. due to the ease of processing. The temperature can be raised which is less desirable due to the propensity for thermal decomposition. It is preferable that the temperature be maintained below the boiling point of the surface modification compound of Formula II. A solvent can be used, particularly, when a surface modification compound is employed which is either a solid or has a viscosity sufficiently high as to be detrimental.

Solvents are optionally employed in some embodiments. Solvents are particularly preferred for use with surface modification compounds that are not liquid under the conditions of operation. Polar solvents or non-polar solvents, such as water, ethers, polyethers, and tetrahydrofuran can be employed. Particularly preferred solvents include water, diethylene glycol diethyl ether, diphenyl ether, diphenyl and dibenzyl ether, and dimethylsulfoxide.

A catalyst can be incorporated wherein the catalyst facilitates the condensation reaction. Acids and bases can function as catalyst. If the pH is to low, or to high, degradation of the surface modification compound and/or derivatized surface can occur. It is preferable that the pH be at least 3 to no more than about 11. Below about 3 the oxide surface is harder to derivatize and the surface modification compound may decompose. Above a pH of about 11 the surface may be overly reactive leading to side reactions and the surface modification compound may decompose. The surface may also be charged by the catalyst to attract or repulse molecules thereby modifying the environment at the surface.

The invention will be described with reference to the figures which are an integral non-limiting component of the disclosure.

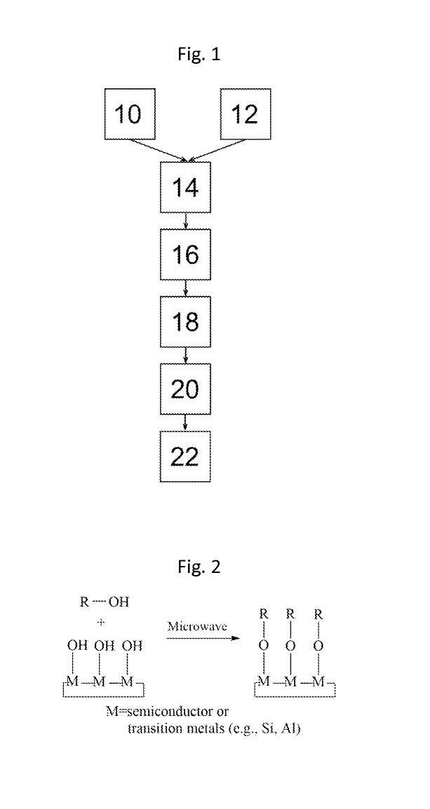

An embodiment of the invention will be described with reference to FIG. 1 wherein the invention is illustrated in flow chart form. In FIG. 1, a substrate is provided at 10. The surface of the substrate is either received with, or treated to have, reactive hydroxyl (e.g., silanol) or oxide groups thereon. A reactant phase is prepared at 12 wherein the reactive phase comprises a surface modification compound of Formula II either neat or optionally as a mixture with at least one of a solvent, a catalyst, or additives to adjust pH. The reactant phase and surface are combined at 14 and subjected to microwave energy at 16. The microwave energy is of sufficient energy and duration to cause a condensation reaction between the reactive hydroxyl or oxide species and surface modification compound thereby forming a derivatized surface at 18. The derivatized surface is optionally cleaned at 20. In one embodiment any solvent, catalyst, reaction by-products, non-reacted surface modification compound, physically adsorbed organic molecules and contaminates can be removed by washing or by a Soxhlet extraction in a suitable solvent. The derivatized surface is optionally further treated at 12 or 14, following the same processes at 16 and at 18 and optionally at 20 as outlined above. The derivatized surface is optionally further treated at 22 wherein the surface modification compound is further reacted.

An embodiment of the invention will be described with reference to FIG. 2 wherein the surface is modified by alkyl alcohols as a representative surface modification compound without limit thereto. In FIG. 2 a substrate surface, represented generically, with chemically accessible hydroxyl, and preferably silanol, functional groups is treated with a representative 900 W microwave energy in the presence of exemplary alcohol for a representative 10 minutes. The silanol group and hydroxyl group of the alcohol condense liberating water and forming a derivatized surface. In FIG. 2 the alcohol is represented as 1-butanol, 1-octanol and 1-octadecanol with the understanding that these are exemplary and the invention is not limited thereto.

The substrate may be a chemically homogenous material or may be represented by a core-shell structure wherein a core has a reactive hydroxide, preferably a silicon hydroxide, on the surface thereof either as a complete shell or on portions of the core. In one embodiment the surface may comprise regions with a reactive region, such as a reactive hydroxide, and other regions with no reactive surface wherein the non-reactive regions are not derivatized as described herein thereby allowing a surface to be selectively decorated allowing for multiple functionalities. By way of non-limiting example, the surface may have regions which are derivatized and other regions which are either more or less conductive than the derivatized region. The substrate, or surface of the substrate, may include silica; silicates, such as quartz; silica oxides; or any other surface including silicon which either has, or is modified to have, reactive hydroxyls. The present invention allows for the use of an abundance of commercially available materials which are not easily derivatized, but which can now be derivatized to allow for a myriad of applications.

The shape of the substrate is not particularly limited herein. The substrate comprising the reactive silanol containing surface may be on a large element with a relatively low ratio of surface area to volume, such as a wafer or monolith, or the surface may be small particles, such as beads, with a relatively large ratio of surface area to volume. A larger element may be suitable for fixed applications whereas smaller particles may be more suitable for applications involving packing or where large relative surface area is desirable. The substrate may be a solid or may be a porous material wherein the interstitial surfaces are optionally derivatized in accordance with the instant invention. Non limiting examples of suitable surfaces include silicon wafers which may be polished; glasses such as soda-lime, float glass, polished glass, etched glass, drawn glass or borosilicate glass; quartz and other silicates; silica nanoparticles or nanomaterials; silica coated surfaces; porous silica; fumed silica; fibers such as glass fibers; silica columns; silica (SiOx) thin films such as films that are >1 nm thick, silicon, silicones, and particles of similar compositions.

Microwave energy is a type of RF electromagnetic wave with frequency ranging from 300 GHz to 300 MHz. A typical microwave oven operates at 2.45 GHz and industrial scale ovens are typically about 915 MHz. For the purposes of the instant invention the microwave energy and frequency is selected for convenience with a preference for an optimum frequency wherein the frequency is matched to the dipole moment of the reactants. Heating rate of the molecules typically increases with dipole moment and the heating rate may be increased by the incorporation of ions. A conductive substrate would be expected to increase the temperature as the microwave induces electric current thereby causing a conductive material to function as a heat source. Microwave heating comes from three sources: dielectric loss, mangnetic loss, and conduction loss. When microwave propagates through a material, the microwave is absorbed in the material, and gets converted to heat. The dielectric loss describes the absorption of microwave due to dielectric properties of the material. Conduction loss refers to the absorption of microwave induced by electronic conduction in the material. Magnetic loss describes the absorption of microwave due to response of a material to a magnetic field. Detailed description and equations for microwave heating is in many prior art, including Microwaves and Metals by M. Gupta and W. W. E. Leong, Wiley, 2007. Microwaves are an efficient method of heating which brings temperature and pressure up beyond what cannot be achieved with conventional heating methods and the heating is achieved at the reactant as opposed to requiring heat to permeate from the outside of the reaction vessel. The substrate heats up faster and more efficiently than the solution therefore the temperature at the solid/liquid interface may be higher than the solution temperature. The substrate heating depends on material properties such as conductivity and is therefore not linearly dependent. This substrate heating can catalyze the formation of monolayers in two ways: first is in acceleration of condensation reaction between the hydroxyl group containing compound and oxide surfaces. Second is in removing water at the surface that was previously adsorbed on the surface and water produced as a by-product from the condensation reaction.

A particular advantage is the ability to form a single molecule thick film, or monolayer without changing or compromising the bulk material properties such as dimension, conductivity and heat transfer properties thereby allowing the surface reactivity or functionality to be selectively modified. A monolayer with a thickness which is nominally the length of the surface modification compound is hypothesized, and observed, as the surface modification compound extends essentially linearly away from the surface in, optimally, a close arrangement.

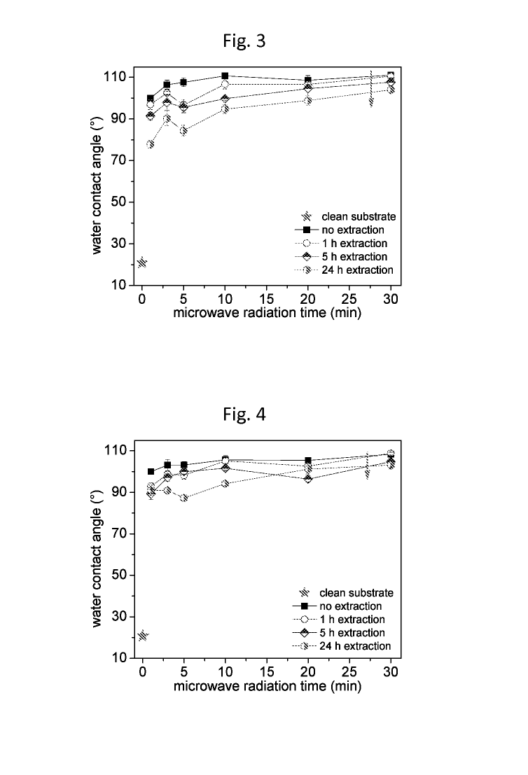

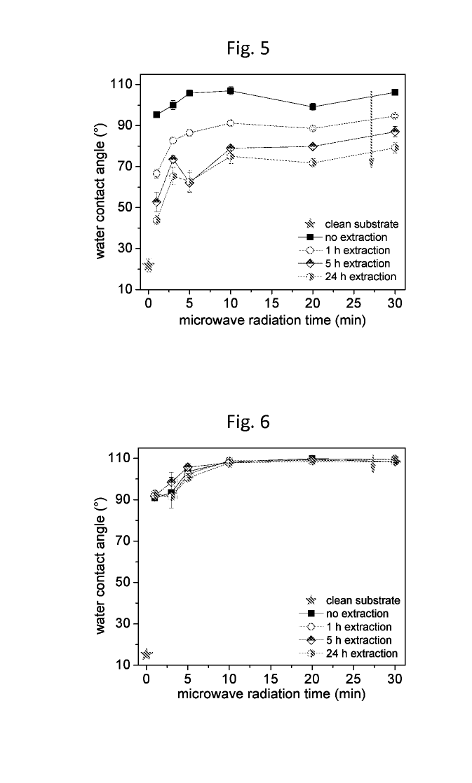

FIGS. 3-6 illustrate materials formed on various surfaces and the results of water contact angle after extraction. In the controls the substrate was subjected to microwave radiation for a set time, in toluene/hexadecane, or the substrate was immersed overnight at room temperature in C₈H₁₇OH, without the benefit of microwave energy, using different substrates. The water contact angle (WCA) was measured as a function of microwave time with the results of the microwave test presented in FIGS. 3-6 wherein the native oxide substrate, FIG. 3, the thermal oxide substrate, FIG. 4, the soda lime substrate, FIG. 5, and quartz substrate, FIG. 6 all have an initial WCA indicative of no surface derivatization.

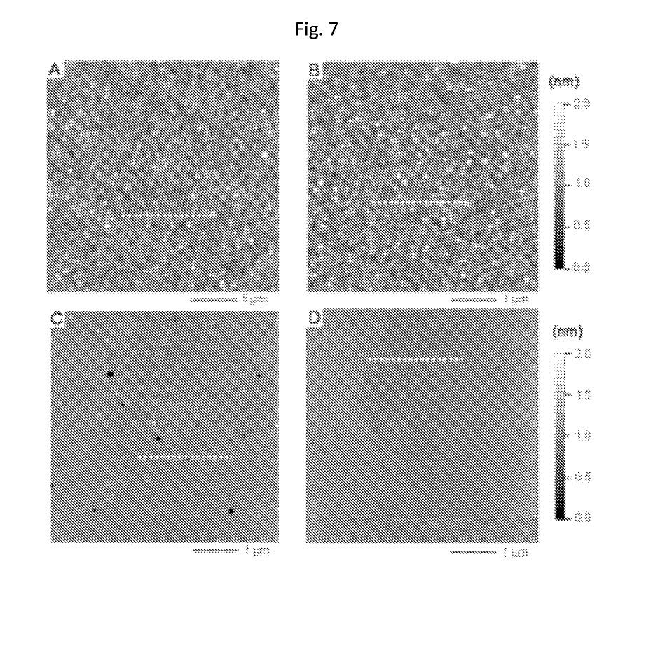

FIG. 7 shows an atomic force microscopy (AFM) study wherein A and B are a dry thermal oxide substrates with 100 nm oxide depth after immersion in 1-octanol for 1 min (A) and 30 min (B) of microwave radiation; C & D are images of a native oxide substrate after immersion in 1-octanol for 1 min (C) and 30 min (D) of microwave radiation. The black “holes” in C are about 1 nm deep. Cross-section analysis on the AFM images of the native oxide samples indicate that the height difference between black spots & light grey area is about 1 nm which is representative of an octanol length thereby suggesting octane extending from the surface.

In one embodiment of the invention a double layer formation may be obtained wherein one end of the surface modification compound extends away from the surface thereby forming a surface which is, by way of example, hydrophobic. A second layer of surface modification compound, or a polar compound, may form a second layer wherein the hydrophobic end is aligned towards the surface modification compound adhered to the surface with the other extending further away from the surface. By way of non-limiting example, octanol oriented in a double layer would have the oxygen, of the alcohol, attached to the surface with the octane group extending away from the surface. A second layer of 1-octanol would align with the alcohol group extending further away thereby forming a double layer with a thickness of 2˜3 nm thick. The ability to form the equivalent of a micelle extends the material manipulation for the inventive derivatized surfaces.

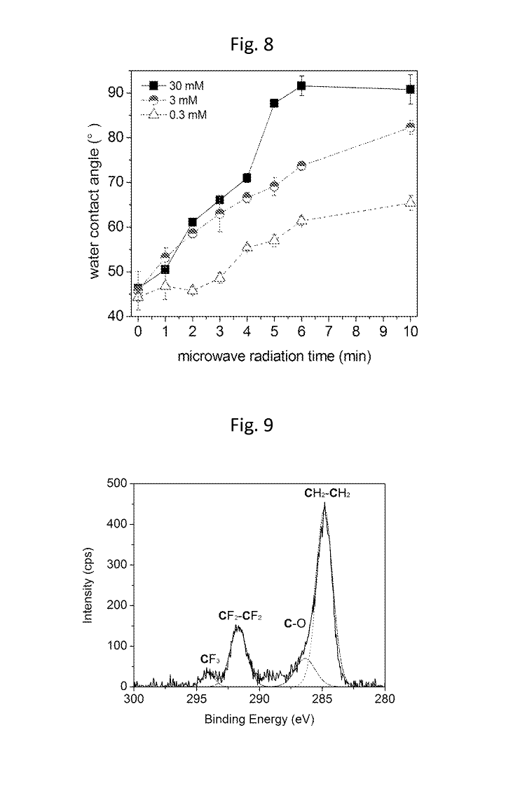

FIG. 8 illustrates the water contact angle as a function of radiation time with various concentrations of 1H,1H,2H,2H-perfluorodecyldimethylchlorosilane (FDDCS) of formula ClSi(CH₃)₂C₂H₄C₈F₁₆CF₃. While not limited to theory, the FDDCS is hypothesized to react with water to liberate a chloride thereby forming a silanol. During microwave radiation, dehydration forms a Si—O—Si bond at the surface of the substrate. As can be seen from FIG. 8 the water contact angle increases with increasing radiation time and concentration reaching an apparent maximum of about 90°. An X-ray Photoelectron Spectrum (XPS) of the surface derivatized with FDDCS is provided in FIG. 9 illustrating the presence of the ethylene group and perfluorinated groups.

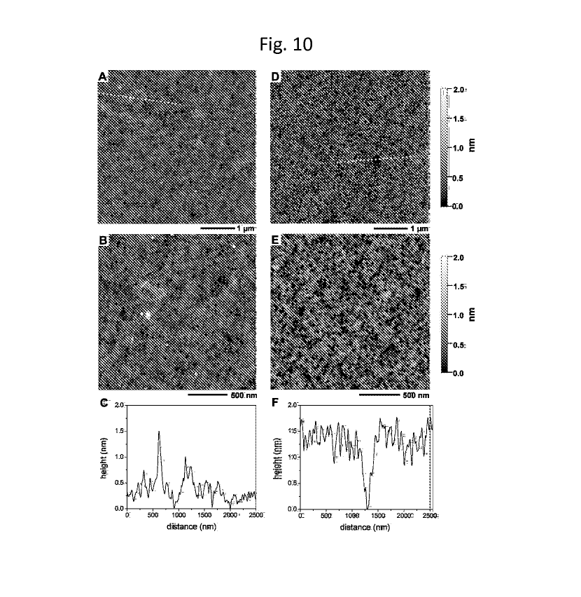

FIG. 10 is an atomic force microscopic (AFM) image of the surface derivatized with FDDCS in toluene (10 mM) at different microwave times and under different magnifications. As can be seen the FDDCS moiety on the surface extends a distance representative of the FDDCS length.

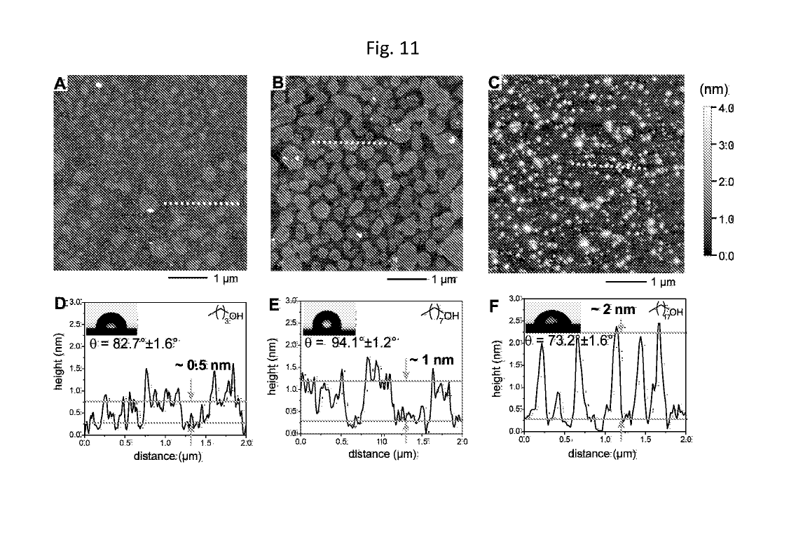

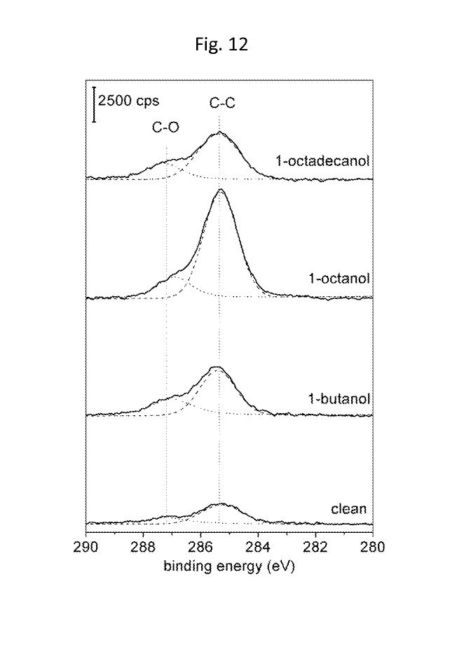

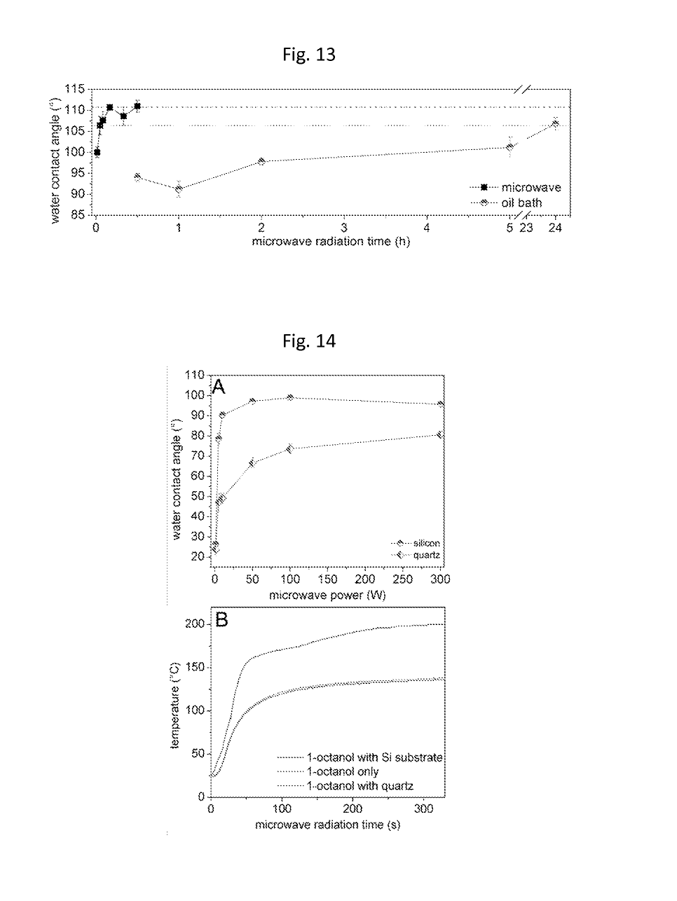

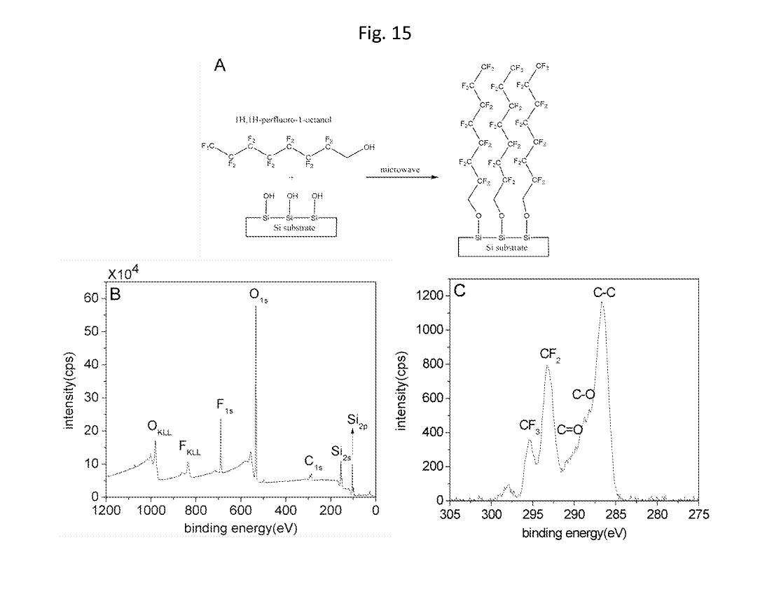

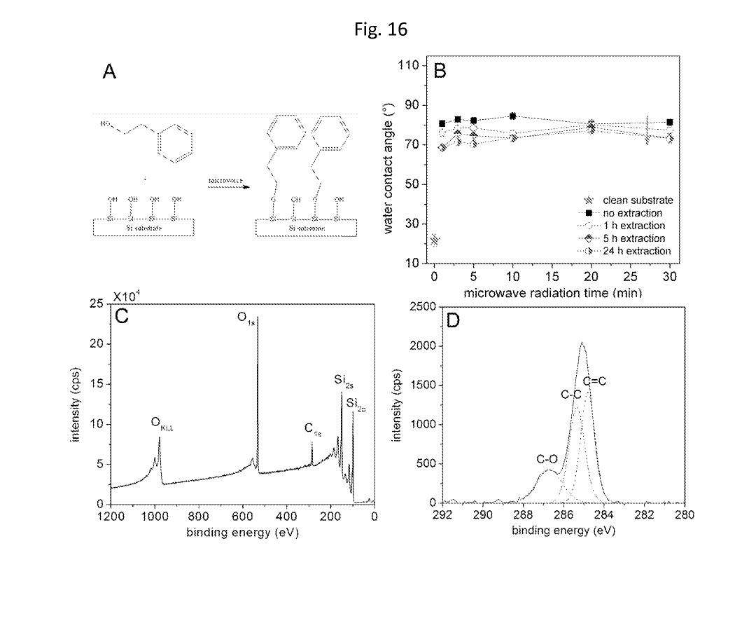

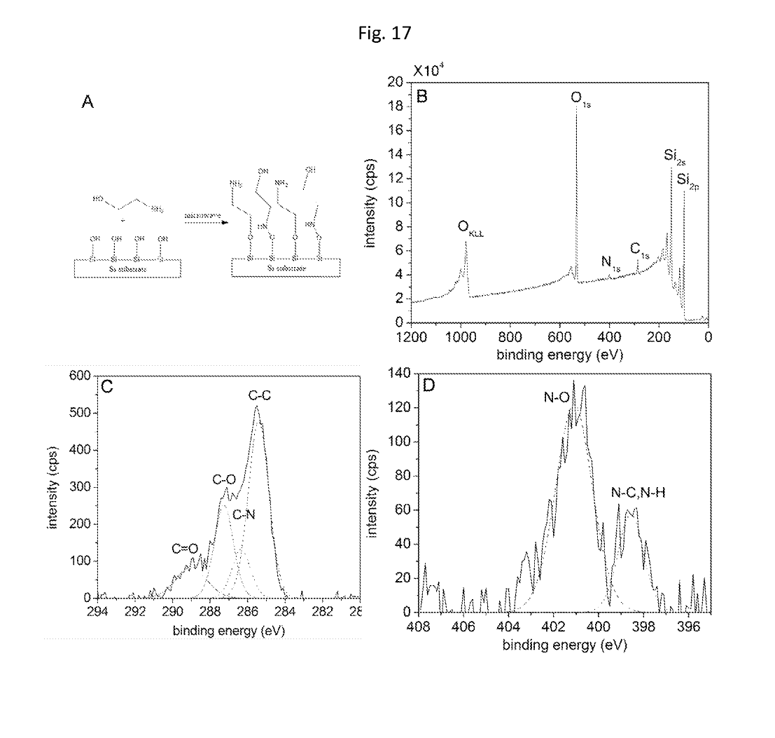

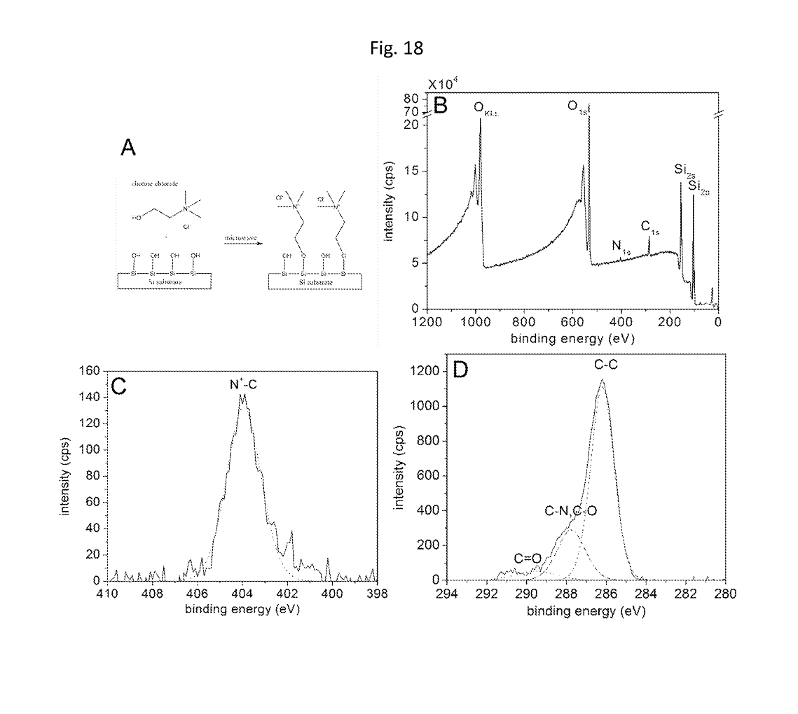

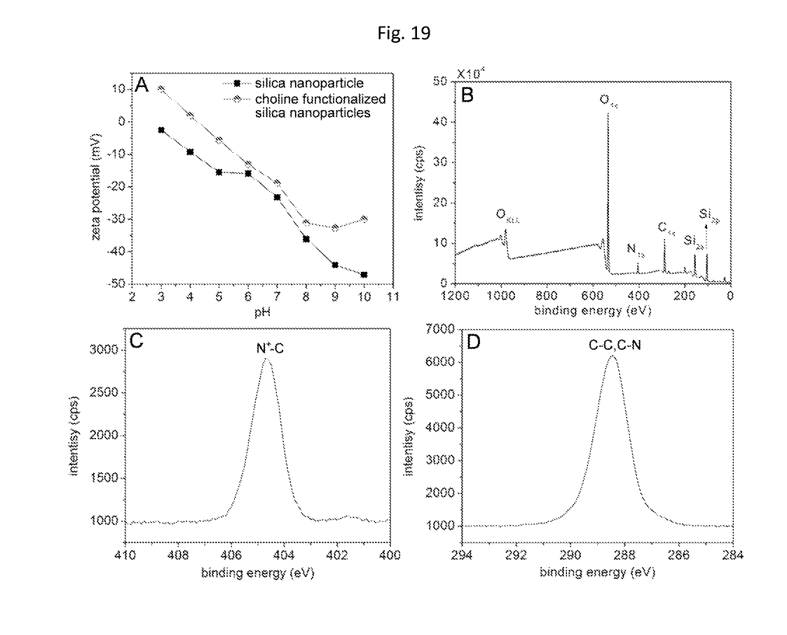

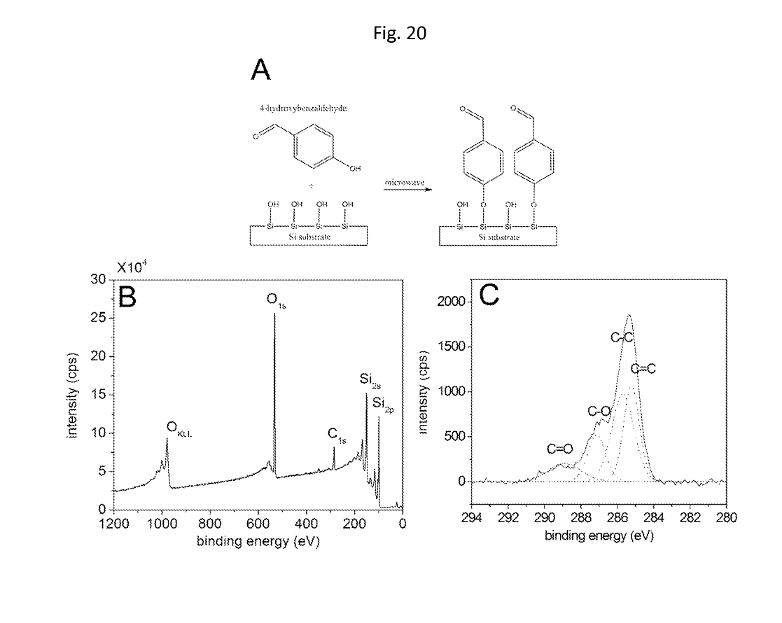

FIG. 11 provides AFM images of surfaces derivatized with 1-butanol, 1-octanol and 1-octadecanol. The 1-octadecanol was used as a 10 mM concentration in toluene. In each case the distance from the surface of the substrate to the surface of the organic layer is approximately representative of the length of the alcohol used to derivatize the surface. The XPS spectra for the same examples is provided in FIG. 12 wherein the quantity of the amount of carbon on the surfaces is determined. The curve at the bottom is the clean substrate, which has the lowest carbon peak of all. The second curve above it is 1-butanol, which has a higher carbon peak, but lower than the 1-octanol C peak. 1-octanol has the highest carbon peak. Though not bound by theory, this is believed to be due to relatively good quality SAMs and the process limitations of preparing surface derivatives with the reasonably long carbon chain of 1-octadecanol. Ideally, the 1-octadecanol should be the highest carbon peak because it has the longest aliphatic chain, but the low density of SAMS compromised the C peak.

Microwave generation is well known technology and a conventional microwave generation cavity is suitable for demonstration of the invention. A cavity magnetron, usually made up of copper, is kept in typically vacuum. The cathode becomes negatively charged by high power DC causing electrons to be ejected at the cathode surface wherein the electrons are attracted toward the outer cavity due to a permanent magnet imposed to the magnetron via Lorentz force. When electrons approach the cavity, they travel in such a way that it generates induced, resonant frequency, and a portion of this electric field is extracted with a short antenna connected to a waveguide.

The invention has been described with reference to the preferred embodiments without limit thereto. One of skill in the art would realize additional embodiments and improvements which are not specifically set forth herein but which are within the scope of the invention as more specifically set forth in the claims appended hereto.

Claimed is:

1. A modified surface comprising 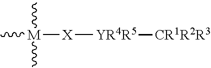
on a substrate wherein:
M is a semiconductor or transition metal element;
X is selected from O, S;
Y is selected from C, Si, P, N;
R⁴ and R⁵ are independently selected from H; single or double bonded oxygen; halogens; substituted or unsubstituted straight or branched alkanes, alkenes or alkynes of 1 to 5 carbons.
R¹, R², and R³ are independently selected from H with the proviso that no more than 2 of R¹, R², and R³ are hydrogen; substituted or unsubstituted straight or branched alkanes, alkenes or alkynes of 1-100 carbons; R¹, R², and R³ can be taken in pairs to represent substituted or unsubstituted cyclic alkane, cyclic alkene or cyclic alkyne; R¹, R², and R³ can be independently selected from halogens; and —(R⁶O)_{z}—R⁷ wherein R⁶ is an alkyl of 1-3 carbons; R⁷ is a terminal group.

2. The modified surface of claim 1 wherein said M is selected from the group consisting of Si and Al.

3. The modified surface of claim 1 wherein at least one of said R¹, R² or R³ independently comprise 1-20 carbons.

4. The modified surface of claim 1 wherein at least one of said R¹, R² or R³ is independently substituted with at least one substituent selected from halogens, hydroxyls, amines, aryl, sulfates, phosphates, alkyl ethers, alkyls, cyclic alkyls, ketones, aldehydes, carboxylic acids, esters, nucleic acids, amino acids, sugars, carbohydrates, hormones, proteins, neurotransmitters, catechols, ethers, ionic groups, organo-sulfurs, —N═N—, —N═N═N—, or combinations thereof.

5. The modified surface of claim 4 wherein at least one of said R¹, R², and R³ is independently substituted with at least one fluorine.

6. The modified surface of claim 5 wherein at least one of said R¹, R² or R³ is a perfluorinated.

7. The modified surface of claim 1 wherein said R⁶ is —CH₂CH₂—.

8. The modified surface of claim 1 wherein said R⁷ is selected from —OH and an alkyl of 1 to 3 carbons.

9. The modified surface of claim 1 wherein said substrate is selected from glass; quartz; silica nanoparticles; silica coated surfaces; porous silica; fumed silica; fibers; silica columns; silica (SiOx), silicon and silicone.

10. The modified surface of claim 1 wherein said surface comprises the condensation product of a surface modification compound selected from the group consisting of: saturated and unsaturated alcohols with 1 to 100 carbons; polyalklene glycol; fluorinated alcohols; phenyl alcohols; polar alcohols; vitamins; sugars; amino acids; nucleic acids; catechols; hormones; neurotransmitters; saturated and unsaturated thiols with 1 to 100 carbons; fluorinated thiols, chlorosilanes with substitute or unsubstituted, saturated or unsaturated alkyl groups with 1 to 100 carbons.

11. The modified surface of claim 10 wherein said surface modification compound is selected from the group consisting of: saturated and unsaturated alcohols with 1-50 carbons; polyethylene glycol with a molecular weight low enough to be liquid at 25° C.; perfluorinated alcohols; phenyl alcohols with a formula of HODC₆H₅ wherein D represents a bond or a saturated or unsaturated alkyl of 1-6 carbons; alkanolamines with 2-4 carbons; thiamine; ascorbic acid; cholecalcifero; riboflavin; vitamin E; ergocalciferol; pantothenic acid; pyridoxal; pyridoxamine; n-acetylglucosamine; glucosamine; D-glucose; sucrose; serine; threonine; tyrosine; adenosine triphosphate; adenosine monophosphate; catechol; catechin; dopamine; norepinephrine; epinephrine; cholesterol; testosterone; saturated and unsaturated thiols with 1-50 carbons; perfluorinated thiols; chlorosilanes with saturated and unsaturated alkyl groups with 1-50 carbons and chlorosilanes with fluorinated alkyl groups and particularly

12. A method of forming a modified surface comprising:
combining a substrate comprising a surface comprising a reactive group with a surface modification compound defined by Formula II
Z—YR⁴R⁵—CR¹R²R³ Formula II
wherein Z of Formula II is a leaving group;
Y is selected from C, Si P, N;
R⁴ and R⁵ are independently selected from H; single or double bonded oxygen; halogens; substituted or unsubstituted straight or branched alkanes, alkenes or alkynes of 1 to 5 carbons. R¹, R², and R³ are independently selected from H with the proviso that no more than 2 of R¹, R², and R³ are hydrogen; substituted or unsubstituted straight or branched alkanes, alkenes or alkynes of 1-100 carbons; R¹, R², and R³ can be taken in pairs to represent substituted or unsubstituted cyclic alkane, cyclic alkene or cyclic alkyne; R¹, R², and R³ can be independently selected from halogens; and —(R⁶O)_{z}—R⁷ wherein R⁶ is an alkyl of 1-3 carbons; R⁷ is a terminal group; and
subjecting said combination to microwave radiation with an energy and duration sufficient to cause condensation and reaction of said surface modification compound and said reactive group.

13. The method of forming a modified surface of claim 12 wherein said Z is selected from the group consisting of halogens, hydroxyl groups and H.

14. The method of forming a modified surface of claim 12 wherein said surface modification compound is in a solution comprising at least one of a solvent, a catalyst, or a pH adjustment additive

15. The method of forming a modified surface of claim 12 wherein said Z is selected from hydrogen and a halogen.

16. The method of forming a modified surface of claim 12 wherein at least one of said R¹, R² or R³ independently comprise 1-20 carbons.

17. The method of forming a modified surface of claim 12 wherein at least one of said R¹, R² or R³ is independently substituted with at least one substituent selected from halogens, hydroxyls, amines, aryl, sulfates, phosphates, alkyl ethers, alkyls, cyclic alkyls, ketones, aldehydes, carboxylic acids, esters, nucleic acids, amino acids, sugars, carbohydrates, hormones, proteins, neurotransmitters, catechols, ethers, ionic groups, organo-sulfurs, —N═N—, —N═N═N—, or combinations thereof.

18. The method of forming a modified surface of claim 12 wherein at least one of said R¹, R² or R³ are independently substituted with at least one fluorine.

19. The method of forming a modified surface of claim 18 wherein at least one of said R¹, R² or R³ is a perfluorinated.

20. The method of forming a modified surface of claim 12 wherein said R⁶ is —CH₂CH₂—.

21. The method of forming a modified surface of claim 12 wherein said R⁷ is selected from —OH and an alkyl of 1 to 3 carbons.

22. The method of forming a modified surface of claim 12 wherein said surface modification compound is selected from the group consisting of: saturated and unsaturated alcohols with 1 to 100 carbons; polyalklene glycol; fluorinated alcohols; phenyl alcohols; polar alcohols; vitamins; sugars; amino acids; nucleic acids; catechols; hormones; neurotransmitters; saturated and unsaturated thiols with 1 to 100 carbons; fluorinated thiols, chlorosilanes with substitute or unsubstituted, saturated or unsaturated alkyl groups with 1 to 100 carbons.

23. The method of forming a modified surface of claim 22 wherein said surface modification compound is selected from the group consisting of: saturated and unsaturated alcohols with 1-50 carbons; polyethylene glycol with a molecular weight low enough to be liquid at 25° C.; perfluorinated alcohols; phenyl alcohols with a formula of HODC₆H₅ wherein D represents a bond or a saturated or unsaturated alkyl of 1-6 carbons; alkanolamines with 2-4 carbons; thiamine; ascorbic acid; cholecalcifero; riboflavin; vitamin E; ergocalciferol; pantothenic acid; pyridoxal; pyridoxamine; n-acetylglucosamine; glucosamine; D-glucose; sucrose; serine; threonine; tyrosine; adenosine triphosphate; adenosine monophosphate; catechol; catechin; dopamine; norepinephrine; epinephrine; cholesterol; testosterone; saturated and unsaturated thiols with 1-50 carbons; perfluorinated thiols; chlorosilanes with saturated and unsaturated alkyl groups with 1-50 carbons and chlorosilanes with fluorinated alkyl groups and particularly.

24. The method of forming a modified surface of claim 12 wherein said substrate is selected from soda-lime, float glass, polished glass, etched glass, drawn glass, borosilicate glass or glass fibers, silica or silicate coated surfaces, porous silicates, particles of similar composition(s).
